(19) United States
(12) Patent Application Publication
(10) Pub. No.: US 2014/0289142 A1
(43) Pub. Date: Sep. 25, 2014

(54) Method,Apparatus and System for Evaluating A Skill Level of A Job Seeker

(71) Applicant: Stanley Shanlin Gu, Raleigh, NC (US)

(72) Inventor: Stanley Shanlin Gu, Raleigh, NC (US)

(21) Appl. No.: 14/014,317

(22) Filed: Aug. 29, 2013

Related U.S. Application Data
(60) Provisional application No. 61/720,859, filed on Oct. 31, 2012.

(51) Int. Cl. G06Q 10/10

(52) U.S. Cl. CPC G06Q 10/1053
USPC 705/321

(57) ABSTRACT

The present invention discloses method, apparatus and system for evaluating a skill level of a job seeker. The method includes building a code snippet bank from predefined code snippets, obtaining a code snippet of a job seeker, evaluating the skill level of the job seeker based on the code snippet of the job seeker and the code snippet bank.

### CROSS-REFERENCE TO RELATED APPLICATIONS

Provisional application No. 61/720,859, filed on Oct. 31, 2012.

### BACKGROUND OF THE INVENTION

1. Field of the Invention

The present invention relates to automated information processing area. More particularly, the present invention relates to method, apparatus and system for evaluating a skill level of a job seeker.

2. Background of the Invention

Conventional online employment matching services start with listing services that provide a web site for job seekers to submit resumes and personal profiles, and for employers to submit job descriptions. Job seekers manually search the online job list to figure out a list of matched jobs, while employers manually search online resumes and personal profiles to figure out a list of candidates. Many times recruiters do the manual online search and matching for job seekers and employers. The manual online job search and matching process is very inefficient and costive with low accuracy.

To save cost and increase accuracy, there come some automation methods being added to the manual online job search and matching process. The automation methods are typically used to do a simple filtering and matching based on job seeker's information and employer's job information through, for example, keywords matching, attributes matching and subjects functions matching. The keywords matching is to extract keywords from resumes and job descriptions and match them, and keyword matching is completed when the same keyword is found; Attributes matching is to match job seeker attributes with employer's desired attributes for the job and the attribute matching is completed when the same attribute is found; subjects functions matching is to match subjects functions from job seekers with those from employers and the subject function matching is completed when the same subject function is found. for example, if a job seeker is looking for salary of $100,000 but the job salary range is $70,000-$90,000, the job seeker can be obviously filtered out from this job because job seeker information does not match employer's job information, otherwise, those matched job seekers will remain. Then, a list of job seeker candidates that match employer's job is generated based on the matched results. And employers will use the list of job seeker candidates to do further evaluation such as phone screenings, written tests, face-to-face interviews to determine final job candidate.

All the above automation methods of employment matching services can only be used to provide employers a list of matching job seeker candidates through matching basic information from job seekers and employers. The employers need to use the list to do further evaluation, such written tests and interviews to evaluate and finalize a candidate for a job offer.

Apparently, conventional on-line employment matching services, whether manual or with some automation methods, there exist problems of costive, inefficiency and cumbersome procedures.

### SUMMARY OF THE INVENTION

The present invention provides method, apparatus and system to evaluate job seeker skill level to solve the problems of cumbersome procedures, inefficiency and costive of employment matching services.

The method provided by the present invention to evaluate a skill level of a job seeker comprises: building a code snippet bank; obtaining a code snippet of the job seeker; evaluating the skill level of the job seeker based on the code snippet of the job seeker and the code snippet bank.

Further, the method comprises: obtaining information of a job provided by an employer; determining a skill level required for the job based on the information of the job provided by the employer; determining whether to recommend the job seeker based on the skill level of the job seeker and the skill level required by the job provided by the employer.

Further, the code snippet bank comprises predefined code snippets with different levels, and the determining the skill level of the job seeker based on the code snippet of the job seeker and the code snippet bank comprises: determining a grade of the code snippet of the job seeker in the code snippet bank; and determining the skill level of the job seeker based on the grade of the code snippet of the job seeker.

Further, the obtained code snippet of the job seeker comprises image information or text information.

Further, the obtaining a code snippet of the job seeker comprises: obtaining the code snippet of the job seeker through a first user input interface which is provided for the job seeker to enter the code snippet; or obtaining the code snippet of the job seeker through a second user input interface which is provided for the job seeker to select the code snippet from a predefined code snippet bank.

The apparatus provided by the present invention to evaluate a skill level of a job seeker comprises: an input/output device, a storage device and a processor. The input/output device and storage device are connected to the processor through a bus; The storage device is configured to store a code snippet bank; The processor is configured to perform the following operations: obtaining a code snippet of the job seeker through the input/output device; and determining the skill level of the job seeker based on the code snippet of the job seeker and the code snippet bank.

Further, the processor is configured to perform the following operations: obtaining information of a job provided by an employer through the input/output device; determining a skill level required by the job based on the information of the job provided by the employer; and determining whether to recommend the job seeker based on the skill level of the job seeker and the skill level required by the job provided by the employer.

Further, the code snippet bank comprises predefined code snippets with different levels, and the processor is further configured to: determining a grade of the code snippet of the job seeker in the code snippet bank; and determining the skill level of the job seeker based on the grade of the code snippet of the job seeker.

Further, the obtained code snippet of the job seeker comprises image information of text information.

Further, the input/output device is configured to: provide a first user input interface for the job seeker to enter the code snippet; or provide a second user input interface for the job seeker to select the code snippet from a predefined code snippet bank.

The system provided by the present invention for evaluating a skill level of a job seeker comprises: job seeker terminal, employer terminal and server. The job seeker terminal and employer terminal are connected to the server through a network; The server comprises: storage device, and processor. The storage device is connected to the processor through a bus; The storage device is configured to store a code snippet bank; The processor is configured to perform the following operations: obtaining a code snippet of the job seeker through the job seeker terminal; and determining the skill level of the job seeker based on the code snippet of the job seeker and the code snippet bank.

Further, the processor is configured to perform the following operations: obtaining information of a job provided by an employer through the employer terminal; determining a skill level required by the job based on the information of the job provided by the employer; and determining whether to recommend the job seeker based on the skill level of the job seeker and the skill level required by the job provided by the employer.

Further, the code snippet bank comprises predefined code snippets with different levels and the processor is further configured to: determining a grade of the code snippet of the job seeker in the code snippet bank; and determining the skill level of the job seeker based on the grade of the code snippet of the job seeker.

Further, the obtained code snippet of the job seeker comprises image information or text information.

Further, the job seeker terminal is configured to: provide a first user input interface for the job seeker to enter the code snippet; or provide a second user input interface for the job seeker to select the code snippet from a predefined code snippet bank.

In summary, utilizing the method, apparatus and system provided by the present invention, we can evaluate job seeker's skill levels based on job seeker's code snippets, fully automate matching job skill requirement and job seeker's skill levels, reduce evaluation procedures of face-to-face interview and written tests, increase efficiency of evaluating job seeker's skill levels and reduce cost of the employment matching process. In addition, through verification process, we can prevent job seeker from providing false information, guarantee the authenticity and reliability of the job seeker's code snippets, in return guarantee the authenticity and accuracy of evaluation result of the job seeker's skill levels.

### BRIEF DESCRIPTION OF THE DRAWING

FIG. 1 is flow diagram of a method for evaluating a skill level of a job seeker;

FIG. 2 is an other flow diagram of another method for evaluating a skill level of a job seeker;

FIG. 3. is structure diagram of an apparatus for evaluating a skill level of a job seeker;

FIG. 4. is another structure diagram of another apparatus for evaluating a skill level of a job seeker;

FIG. 5. is another structure diagram of another apparatus for evaluating a skill level of a job seeker;

FIG. 6. is another structure diagram of another apparatus for evaluating a skill level of a job seeker;

FIG. 7. is structure diagram of a system for evaluating a skill level of a job seeker;

FIG. 8 is overall process flow of the system for evaluating a skill level of a job seeker;

FIG. 9 is data diagram for job seeker information of system of the present invention;

FIG. 10 is data diagram for employer information of the system of the present invention;

FIG. 11 is data diagram for code snippet bank of the system of the present invention;

FIG. 12 is data diagram for job seeker code snippet entry of the system of the present invention;

FIG. 13 is data diagram for job seeker skill levels calculation the system of the present invention;

FIG. 14 is data diagram for employer job skill levels entry of the system of the present invention;

FIG. 15 is flow diagram of skills and levels matching of the system of the present invention;

FIG. 16 is data diagram of job seeker job preferences entry of the system of the present invention;

FIG. 17 is data diagram of employer job preferences entry of the system of the present invention;

FIG. 18 is flow diagram of job preferences filtering process of the system of the present invention;

FIG. 19 is flow diagram of instant job offer process of the system of the present invention;

### DETAILED DESCRIPTION OF THE INVENTION

Conventional online employment services only utilize basic requirements such as expected salary and job location, etc to do job matching and it lacks a method to evaluate a job seeker's skill levels precisely. Thus, a rigid interview process and/or written test is a must step to determine a right individual who can perform a job at the level expected by employer. Even though some keywords can tell job seeker's job experience or skill, the true skill and level has not be verified. For example, a job seeker who has very minimum ASP.NET experience putting ASP.NET for a keyword will be picked by the conventional automation methods for position of ASP.NET developer, but there is no way to know if the job seeker can truly do ASP.NET development work and at what level. For another example, an excellent ASP.NET developer putting Visual Studio 2010 and Web Forms instead of ASP.NET for keywords may not be picked by the conventional automation methods for position of ASP.NET developer, but, actually Visual Studio 2010 and Web Forms mean ASP.NET skill To address the above issues, the present invention utilizes tools information frequently used during job experience to represent job skill levels, build an information bank of such tools information, evaluate job seeker's skill levels through the information bank to select right candidate that meets job requirements exactly, and results in decreasing cost and increasing efficiency of employment matching process. In particular in the area of computer software development and application, software developers frequently use a variety of code snippets as tools information and their skill levels can be represented by the code snippets that they select or use. The following is to describe the present invention in detail using employment service in the area of computer software development area as an example.

What needs be pointed out is, the job seekers mentioned in the following are referred to software developers with typical working titles of, but not limited to Software Developer, Software Engineer, Programmer, Programmer Analyst, Application Developer, Application Architect, Software Architect, System Analyst, IT analyst, etc. The present invention is not limited to specific computer languages; instead, the present invention applies to all computer languages and software development tools that are used for computer programming.

The following is to describe technology solutions of the implementation examples of present invention using the drawings of the implementation examples. Apparently, the described implementation examples are only partial implementation examples of the present invention rather than all the implementation examples. Based on the implementation examples of the present invention, any other non-innovative implementation examples obtained by technologists of the present area are within protection scope of the present invention.

The job seeker skill level evaluation method can be realized through different terminals.

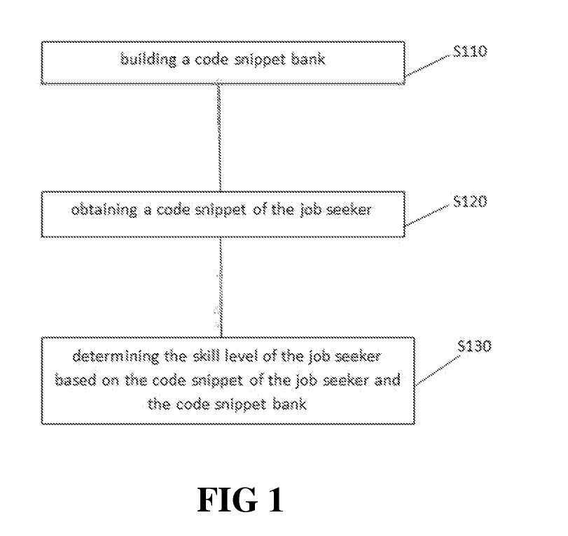

The following is to describe flow of a method for evaluating a skill level of a job seeker of implementation examples of present invention using the drawings of the implementation examples, which is shown by FIG. 1, comprising:

Step S110, building a code snippet bank.

For example, in the area of computer programming, search code snippets that belong to different computer languages such as AS/Flash/Flex, Bash/Shell, C#/.NET, C/C++, CSS, Delphi/Pascal, Google Go, Groovy, HTML/XHTML, Java, Javascript, Jquery, Perl, PHP, Python, Ruby, and define the attributes to the searched code snippets. The code snippets can be ordinary, standard, or customized to a specific project. An ordinary code snippet is defined as primary level and it has a basic score. A standard code snippet is defined as intermediate level and it has a standard score. A customized code snippet is defined as advanced level and it has a specialty score.

Using HTML/XHTML as an example, to set a page as the home page of a web browser, the following code snippet will be used:

<span onclick=“var strHref=window.location.href;this.style.behavior=‘url(#default#homepage)’; this.setHomePage(‘http://doc.codesky.net’);” style=“CURSOR: hand”>set as home page</span>

This code snippet is a common, frequently used and very basic code snippet of HTML/XHTML language. Most software developers who use HTML/XHTML to develop software know this code snippet. Thus this code snippet can be defined as primary level and has a basic score.

For example, using HTML 5 to implement functionality of shaking cell phone, its code snippet is difficult for an average software developer to develop a web application. Only those software developers having developed mobile terminal software can have experience in this code snippet. Thus, this code snippet can be defined as advanced level and has specialty score. Accordingly, by defining attributes to different code snippets, it allows code snippets in the code snippet bank to have different levels of attributes, based on which to conduct job skill level evaluation.

Step S120, obtaining a code snippet of the job seeker.

A job seeker has accumulated certain code snippets that he/she has used or been familiar with after he/she has finished some tasks related to software development during his/her study or working experience. The present invention provides user input interface allowing a job seeker to input his/her code snippets, which can be images or texts, from his/her experience. The present invention can also provide user input interface allowing a job seeker to input his/her code snippets through selecting code snippets from the code snippet bank. The interface includes indexes for predefined code snippets from the code snippet bank. In addition, the present invention can also allow a job seeker to enter his/her code snippets from his/her experience, select code snippet indexes without seeing code snippets from code snippet bank. By comparing user entered code snippets and user selected code snippet indexes, the system can verify and guarantee the authenticity and reliability of the user input code snippets.

Step S130, determining the skill level of the job seeker based on the code snippet of the job seeker and the code snippet bank.

After obtaining job seeker's code snippets, the system will match them to predefined code snippets from the code snippet bank, and determine the job seeker's skill levels according to the attributes and weights of the predefined code snippets from the code snippet bank.

In another embodiment of this invention, the specific step S130 is followed by determining a grade of the code snippet of the job seeker in the code snippet bank and determining the skill level of the job seeker based on the grade of the code snippet of the job seeker.

Using an example of HTML/XHTML design and development to explain it in detail.

The system obtains a code snippet of automatic refreshing a web page from the first job seeker and a code snippet of plug-in video in html5 page from the second job seeker.

The code snippet of automatic refreshing a web page is defined as primary level and has a basic score. The code snippet of plug-in video in html5 page is defined as intermediate level and has a standard score. It is easy to determine that the second job seeker has a higher skill level than that of the first job seeker.

Apparently, utilizing the method provided by the present invention, we can evaluate job seeker's skill levels based on job seeker's code snippets, reduce evaluation procedures of face-to-face interview and written tests, increase efficiency of evaluating job seeker's skill levels and reduce cost of the employment matching process. In addition, through verification process, we can prevent job seeker from providing false information, guarantee the authenticity and reliability of the job seeker's code snippets, in return guarantee the authenticity and accuracy of evaluation result of the job seeker's skill levels.

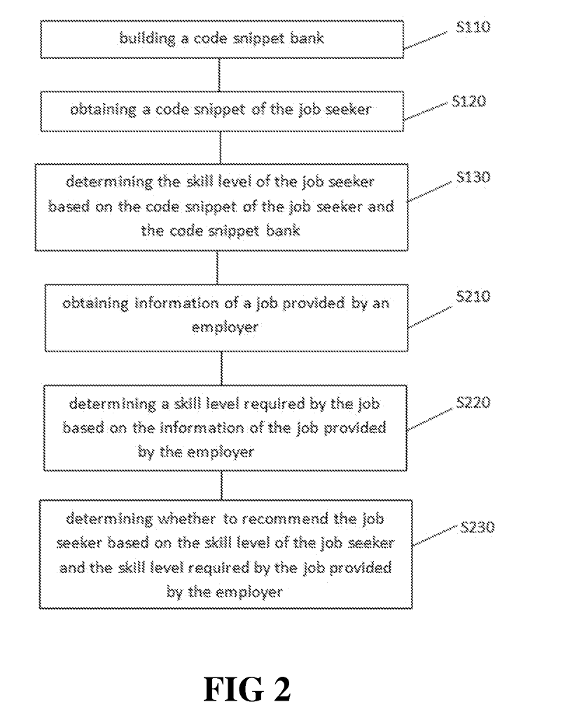

Further, referring to FIG. 2, another method for evaluating a skill level of a job seeker includes following steps:

Step S210, obtaining information of a job provided by an employer.

For example, the system provides user input interface for the employer to enter job information such as name, requirement and salary, etc. The skill levels required by the job can be entered by selecting attributes of predefined code snippets from the code snippet bank, connecting the job skill levels to the code snippets from the code snippet bank.

Step S220, determining a skill level required by the job based on the information of the job provided by the employer.

For example, in the area of computer software development, an employer provides job requirement for job it publishes. If the job requires advanced levels of HTML/XHTML development skills, the employer will select HTML/XHTML code snippets with advanced level attributes from the code snippet bank. In other words, the employer will select all code snippets related to HTML/XHTML first, then narrows down by selecting code snippets related to HTML/XHTML with advanced level attributes only.

Step S230, determining whether to recommend the job seeker based on the skill level of the job seeker and the skill level required by the job provided by the employer.

Using the above evaluation method to determine the job seeker's skill levels, fields that the skills belong to, and the skill level scores, then matching them against job's required skill fields, skill level scores to determine whether the job seeker's skill levels are matching to the job's required skill levels, in return, to determine whether to recommend the job seeker for the job.

Apparently, utilizing the method provided by the present invention, we can evaluate job seeker's skill levels based on job seeker's code snippets, complete matching job seeker and job, reduce evaluation procedures of face-to-face interview and written tests, fully automate matching job skill requirement and job seeker's skill levels, increase efficiency of evaluating job seeker's skill levels and reduce cost of the employment matching process.

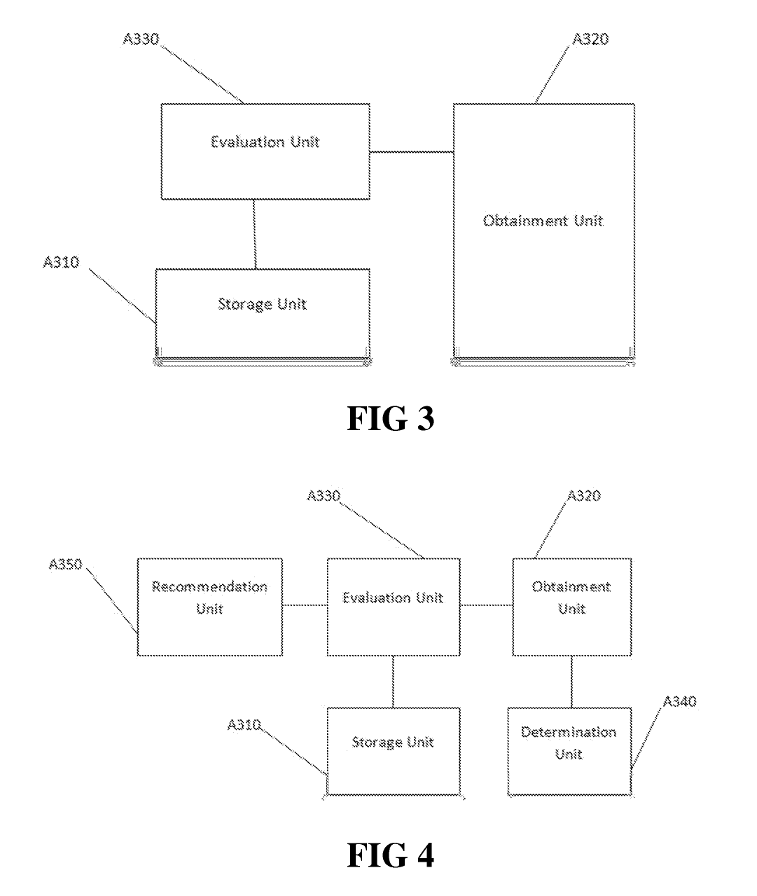

The following we describe in detail about an apparatus for evaluating a skill level of a job seeker. Referring now to FIG. 3, which shows a structure diagram of the apparatus for evaluating a skill level of a job seeker.

The job seeker skill level evaluation apparatus, includes: storage unit A310, obtainment unit A320 and evaluation unit A330. The storage unit A310 is used to store predefined code snippets for the code snippet bank. The obtainment unit A320 is used to obtain job seeker's code snippets. The evaluation unit A330 is used to evaluate the job seeker's skill levels based on job seeker's code snippets and predefined code snippets from the code snippet bank.

Apparently, utilizing the apparatus provided by the present invention, we can evaluate job seeker's skill levels through obtaining job seeker's code snippets, reduce evaluation procedures of face-to-face interview and written tests, fully automate matching job skill requirement and job seeker's skill levels, increase efficiency of evaluating job seeker's skill levels and reduce cost of the employment matching process.

Further, referring now to FIG. 4, which shows another structure diagram of an other apparatus for evaluating a skill level of a job seeker. The obtainment unit A320 is also used to obtain employer's job information. And the apparatus includes: determination unit A340, which is used to determine the skill levels required by the job based on the job information. Recommendation unit A350, which is to determine whether to recommend the job seeker based on job seeker's skill levels and skill levels required by the job.

Apparently, utilizing the apparatus provided by the present invention, we can evaluate job seeker's skill levels through obtaining job seeker's code snippets; complete matching job seeker and the job; reduce evaluation procedures of face-to-face interview and written tests; fully automate matching job skill requirement and job seeker's skill levels; increase efficiency of evaluating job seeker's skill levels and reduce cost of the employment matching process.

Further, the code snippet bank has code snippets with different levels. The evaluation unit A330 is used to determine the levels of the job seeker's code snippets in the context of the code snippet bank, and determine the job seeker's skill levels based on the determined code snippet levels.

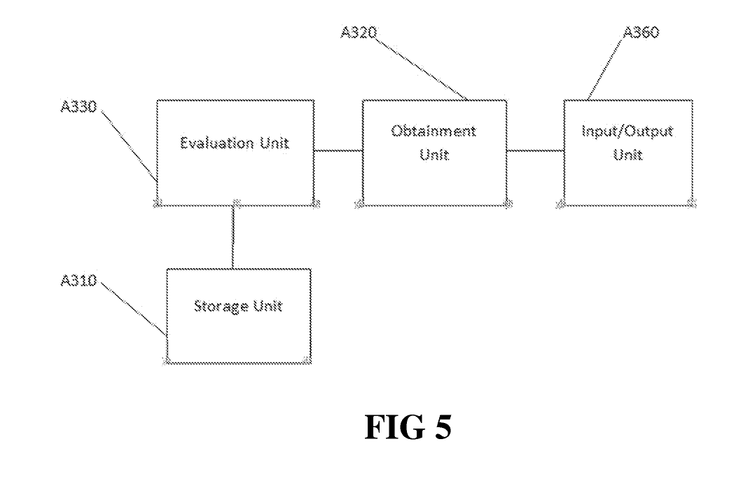

Further, referring now to FIG. 5, which shows another structure diagram of another apparatus for evaluating a skill level of a job seeker, includes: input/output unit A360 is to provide user input interface for job seeker to enter job seeker's code snippets; and/or, provide user input interface for job seeker to select code snippets from predefined code snippets of the code snippet bank. Through the input/output unit A360, the obtainment unit A320 is used to obtain job seeker's code snippets.

The present invention also provides a system that includes the above apparatus.

Apparently, utilizing the apparatus and system provided by the present invention, we can evaluate job seeker's skill levels through obtaining job seeker code snippets; fully automate matching job skill requirement and job seeker's skill levels, reduce evaluation procedures of face-to-face interview and written tests, increase efficiency of evaluating job seeker's skill levels and reduce cost of the employment matching process. In addition, through verification process, we can prevent job seeker from providing false information, guarantee the authenticity and reliability of the job seeker's code snippets, in return guarantee the authenticity and accuracy of evaluation result of the job seeker's skill levels.

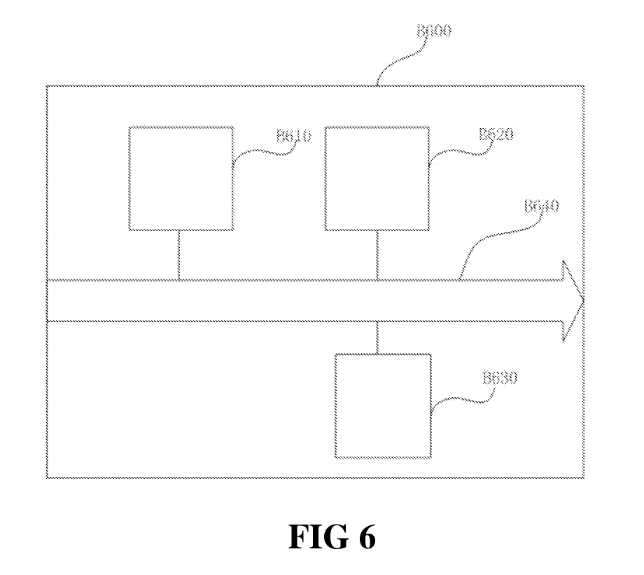

Referring now to FIG. 6, which shows another structure diagram of another apparatus for evaluating a skill level of a job seeker.

The job skill level evaluation apparatus B600, includes: input/output device B610, storage device B620, processor B630. The input/output device B610 and storage device B620 are connected to processor B630 through a bus B640. The storage device B620 is used to store predefined code snippets of the code snippet bank. The processor B630 is used to perform the following operations: obtain job seeker's code snippets through the input/output device B610, and evaluate job seeker's skill levels based on the job seeker's code snippets and the predefined code snippets of the code snippet bank.

Apparently, utilizing the apparatus provided by the present invention, we can evaluate job seeker's skill levels through obtaining job seeker's code snippets, reduce evaluation procedures of face-to-face interview and written tests, increase efficiency of evaluating job seeker's skill levels and reduce cost of the employment matching process.

The processor B630 is also used to perform the following operations: obtain employer's job information through input/output device B610; determine skill levels required by the job based on the job information; determine whether to recommend a job seeker based on the job seeker's skill levels and the skill levels required by the job.

Through the above devices, we can evaluate job seeker's skill levels through obtaining job seeker's code snippets, complete matching job seeker and job, fully automate matching job skill requirement and job seeker's skill levels, reduce evaluation procedures of face-to-face interview and written tests, increase efficiency of evaluating job seeker's skill levels and reduce cost of the employment matching process.

The code snippet bank stored in the storage device B620 has code snippets with different levels. That the processor B630 is used to evaluate job seeker's skill levels based on job seeker's code snippets and predefined code snippets of the code snippet bank includes: determine levels of job seeker's code snippets in the context of the code snippet bank; determine job seeker's skill levels based on the determined job seeker's code snippet levels.

That the input/output device B610 is used to obtain job seeker' s code snippets includes: the obtained job seeker code snippets can be images or texts.

That the input/output device B610 is used to obtain job seeker's code snippets includes: provides user input interface for job seeker to enter code snippets in order to obtain job seeker's code snippets; or provides user input interface for job seeker to select predefined code snippets from the code snippet bank in order to obtain job seeker's code snippets.

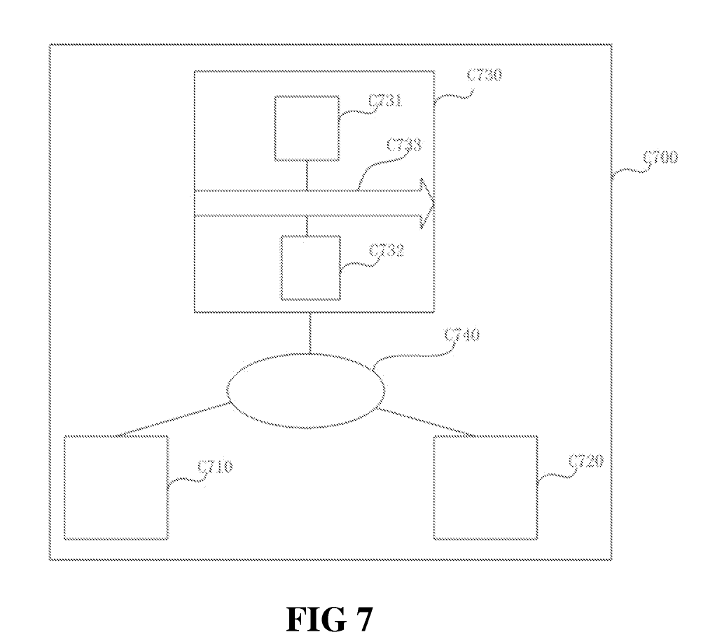

Referring now to FIG. 7, which shows structure diagram of a system for evaluating a skill level of a job seeker.

The system C700 includes: job seeker terminal C710, employer terminal C720, server C730. The job seeker terminal C710 and employer terminal C720 are connected to server C730 through a network C740; The server C730 includes: storage device C731, processor C732. The storage device C731 is connected to processor C732 through a bus C733; The storage device C731 is used to store code snippet bank; The processor C732 is used to perform the following operations: obtain job seeker's code snippets through job seeker terminal C710; evaluate job seeker's skill levels based on job seeker's code snippets and predefined code snippets from the code snippet bank.

The processor C732 is also used to perform following operations: obtain employer's job information through employer terminal C720; determine skill levels required by the job based on the job information; determine whether to recommend the job seeker based on the job seeker's skill levels and the skill levels required by the job.

The code snippet bank stored in the storage device C731 can have code snippets with different levels. The processor C732 is used to evaluate job seeker's skill levels based on job seeker's code snippets and predefined code snippets from the code snippet bank, includes: determine levels of job seeker's code snippets in the context of code snippet bank; determine job seeker's skill levels based on the determined job seeker's code snippet levels.

That the job seeker terminal C710 is used to obtain job seeker's code snippets includes: The job seeker's code snippets can be images or texts.

That the job seeker terminal C710 is used to obtain job seeker's code snippets includes: provides user input interface for job seeker to enter code snippets in order to obtain job seeker's code snippets; provides user input interface for job seeker to select predefined code snippets from the code snippet bank in order to obtain job seeker's code snippets.

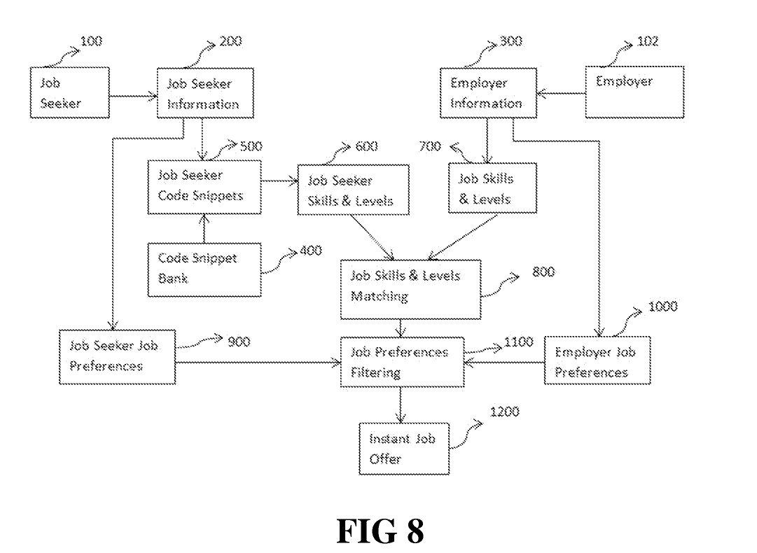

Referring now to FIG. 8, which shows flow diagram of an overall process flow of the system for evaluating a skill level of a job seeker. Job seeker 100 is a professional doing computer language programming and the job seeker's working title is typically, but not limited to Software Developer, Software Engineer, Programmer, Programmer Analyst, Application Developer, Application Architect, Software Architect, System Analyst, IT analyst, etc. The present invention is not limited to specific computer languages; instead, the present invention applies to all computer languages and software development tools that are used for computer programming. The job seeker 100 enters the job seeker information 200 to register when the job seeker accesses the system first time. After registered, the job seeker can login to the system and enter a job seeker code snippet 500 from job experience. The system provides code snippet bank 400, which consists of commonly used code snippets related to different software development skills, for the job seeker to select when the job seeker enters the job seeker code snippet 500. The job seeker code snippet 500 and the selected code snippet from code snippet bank 400 must be functionally identical. As part of the job seeker code snippet 500 entry, the job seeker 100 needs to enter employment histories and projects that the code snippet belong to. Then the system will use the entered job seeker code snippets 500 to calculate the corresponding job seeker skills and levels 600 for the job seeker 100.

The employer 102 enters the employer information 300 to register when the employer accesses the system first time. After registered, the employer can login to the system and enter jobs and required skills and levels 700 for the jobs.

The job skills and levels matching process 800 compares job seeker skills and levels 600 and job skills and levels 700 and come up with a list of candidates that meet job skills and levels 700 requirement. Any candidate of the list is qualified to perform the job at the level expected by the employer 102. The final candidate list is subject to filtering from job preferences filtering process 1100, which uses job seeker job preferences 900 and employer job preferences 1000 to filter a job from a job seeker and a job seeker from a job.

Job seeker job preferences 900 are about job preferences of the job seeker 100, such as desired salary the job seeker is looking for and the job seeker will be filtered out if the job seeker's desired salary is higher than salary range of the job. Employer job preferences 1000 are about job preferences of the employer 102, such as US citizenship required and the job seeker will be filtered out if the job seeker does not have US citizenship. The result from job skills and levels matching process 800 along with job preferences filtering 1100 produce a final list of candidates who can perform the job at the level expected by the employer 102. The candidate of the final list with the highest skill levels based on job skill priority order set by employer gets instant job offer 1200. The system automatically sends a job offer on behalf of the employer 102 to the job seeker 100 and notifies the employer 102 of such job offer in the step of instant job offer process 1200.

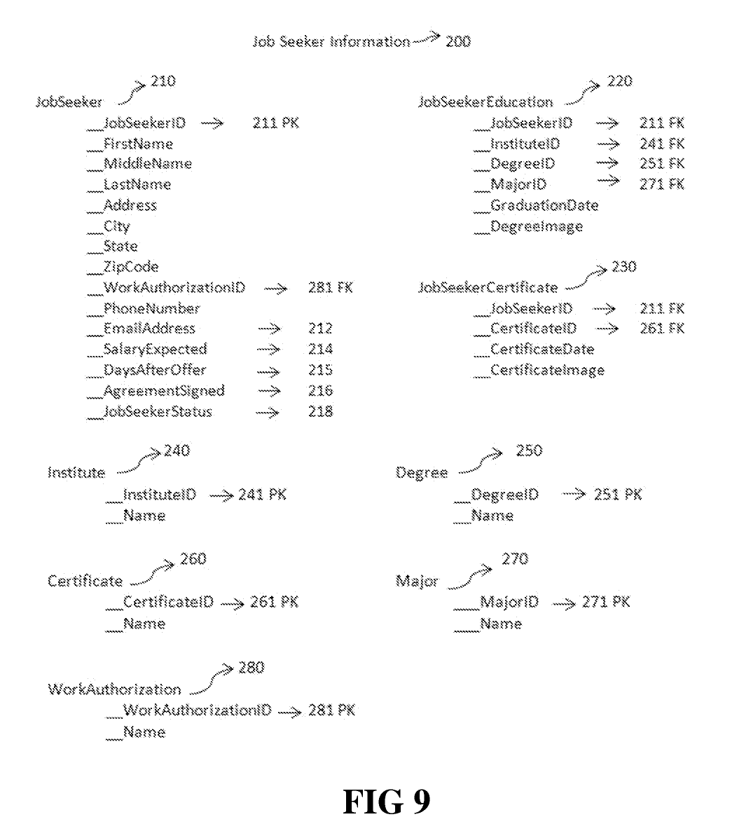

FIG. 9 shows data diagram for the job seeker information 200. The job seeker 100 provides job seeker basic information 210 when the job seeker registers with the system. Some information such as First Name, Last Name, Email Address 212 of the job seeker basic information 210 are required for registration, while others can be provided or updated after the registration. The job seeker information 200 includes job seeker basic information 210, education information 220 and professional certificates information 230. The system contains list of institute 240, degree 250, certificate 260, major 270 and work authorization 280 so that job seeker 100 can select whatever value applied. For example, if job seeker 100 has B.S. degree in Computer Science, the job seeker can select B.S. degree from degree list 250 and Computer Science from major list 270. The job seeker education 220 will have corresponding degree ID 251 and major ID 271 of B.S. and Computer Science. If a job seeker is Permanent Resident, the job seeker can select Permanent Resident from work authorization list 280 and the job seeker basic information 210 will have corresponding work authorization ID 281 of Permanent Resident. Some information such as work authorization ID 281, degree ID 251, major ID 270, certificate ID 261 can be used for filtering job seeker 100 based on employer job preferences 1000. For example, if the job requires US citizenship, B.S. in Computer Science and MCPD (Microsoft Certified Professional Developer) certificate, a job seeker missing any one of those credentials will be filtered out for the employer. Job seeker ID 211, institute ID 241, degree ID 251, certificate ID 261, major ID 271 and work authorization ID 281 are unique identifiers for job seeker 210, institute 240, certificate 260, degree 250, major 270 and work authorization 280 respectively.

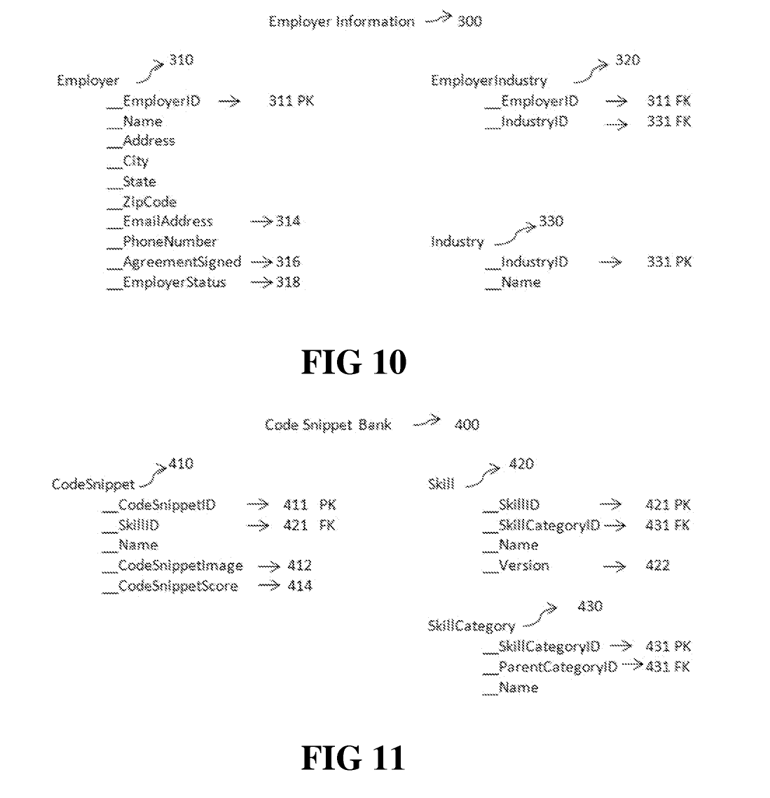

FIG. 10 shows data diagram for employer information 300. The employer 102 provides employer basic information 310 when the employer 102 registers with the system. Some information such as Name, Email Address 314 of the employer basic information 310 are required for registration, while others can be provided or updated after the registration. Employer information 300 includes employer basic information 310 and industry information 320. The system contains list of industry 330 so that the employer 102 can select whatever value applied to the employer. For example, if an employer belongs to industries of Financial Service and Software, the employer can select Financial Service and Software from industry list 330, the employer's industries 320 will have corresponding industry ID 331 of industries of Financial Service and Software. Some information such as industry ID 331 can be used for filtering employer 102 based on job seeker job preferences 900. For example, if the job seeker 100 looks for a job in Financial Service industry, employers that do not belong to Financial Service industry will be filtered out for the job seeker 100. Employer ID 311 and industry ID 331 are unique identifiers for employer 310 and industry 330 respectively.

FIG. 11 shows data diagram for code snippet bank 400. The code snippet bank 400 is provided by the system and has many commonly used code snippets 410 belong to a skill 420, which further belongs to a skill category 430. Version 422 is used because same skill may have different versions and the employer may want specific version of the skill The code snippet image 412 is an image or file of the code snippet. The code snippet score 414 is a numeric number about how much the code snippet weights in its corresponding skill and is defined by the system Skill category ID 431, skill ID 421, code snippet ID 411 are unique identifier for skill category 430, skill 420 and code snippet 410 respectively.

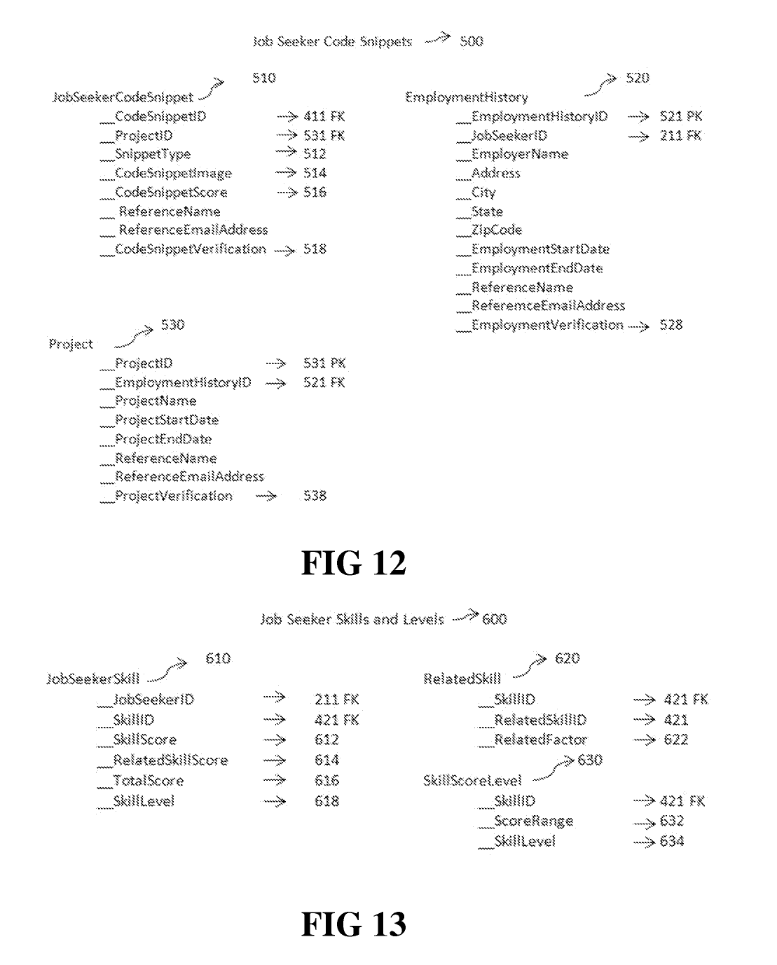

FIG. 12 shows data diagram for job seeker code snippets entry 500. The job seeker 100 enters job seeker code snippets 510 by selecting a code snippet 410 from the code snippet bank 400 and submits the job seeker's code snippet 510 from job experiences that is functionally identical to the selected code snippet 410. The job seeker will select a project 530 that the job seeker code snippet 510 belongs to, and an employment history 520 that the project 530 belongs to. The code snippet type 512 tells the type of job seeker code snippet such as whether the code snippet was developed by the job seeker or the code snippet was just maintained and updated by the job seeker. The code snippet image 514 is an image or file of the job seeker's code snippet and is similar to the code snippet image 412 of the selected code snippet 410. The job seeker 100 enters reference name and reference email address for job seeker code snippet 510, project 530 and employment history 520, and the system uses them to verify and update the code snippet verification status 518, project verification status 538 and employment verification status 528. The system uses value of code snippet score 414 as default value of job seeker code snippet score 516 and further calculates value of job seeker code snippet score 516 based on code snippet verification status 518, project verification status 538, employment verification status 528 and code snippet type 512. Employment history ID 521 and project ID 531 are unique identifiers for employment history 520 and project 530 respectively.

FIG. 13 shows data diagram for job seeker skills and levels 600 calculations. The system calculates skill score 612 for the job seeker 211 and the skill 421 by adding code snippet score 516 of all the job seeker code snippets of the job seeker 211 and the skill 421. Then the system calculates related skill score 614 from related skills 620. The related skills 620 are about two skills that are related and one skill can be counted as factor 622 of an other skill, for example, if skill A is related to skill B with related factor 622 of 10%, then a job seeker who has score for skill A can be counted as score for skill B=score for skill A×10%. A list of related skills 620 is defined and provided by the system. The total score 616 is equal to sum of skill score 612 and related skill score 614. Finally, the system uses the total score 616 to find out skill level 618 from skill level 634 of skill score level scale list 630 that has score range 632 compatible to the total score 616.

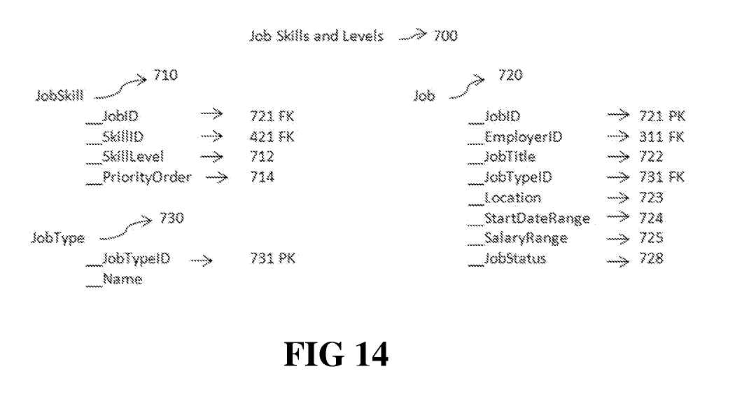

FIG. 14 shows data diagram for the job skills and levels entry 700 by employer 102. The employer 102 enters job information 720 first, then enters skills 421 by selecting one or more skills 421 from skills list 420, and levels 712 required for the job 720 to job skill 710. The priority order 714 is about the priority order of the skills 421 for the job 721. Some information about job 720 such as job type 731, job location 723, job start date range 724, salary range 725 are used for filtering job seeker 100 based on job seeker preferences 900. Job ID 721 and job type ID 731 are unique identifiers for job 720 and job type 730 respectively.

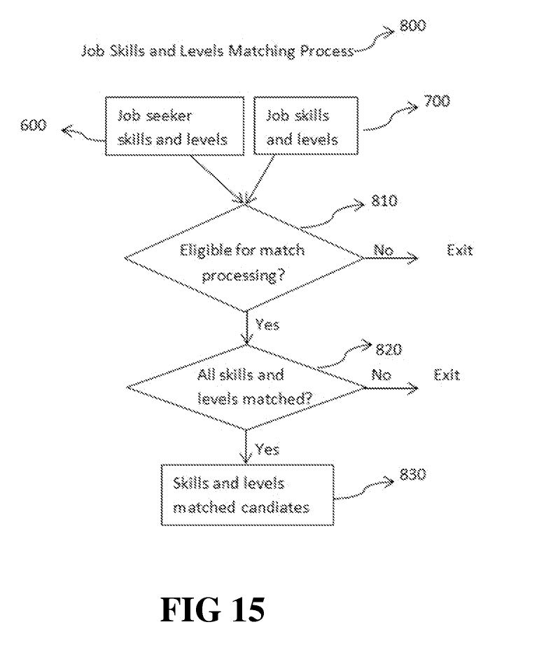

FIG. 15 shows flow diagram of job skills and levels matching process 800. The system first checks whether job seeker 100, employer 102 and job 720 are eligible 810 to participate the matching process. To be eligible for the job skills and levels matching process, the job seeker 100 must have agreement signed 216 and job seeker status 218 is Active, the employer 102 must have agreement signed 316 and employer status 318 is Active and the job status 728 for the job 720 must be Open. Then, the system will check to see if all the skills and levels are matched 820. To determine that, the system will check to see if the job seeker 100 has all the skills 421 from job seeker skill 610 that are required by the skills 421 from job skill 710, and all the skill levels 618 from job seeker skill 610 are equal or higher than skill levels 712 of matched skills from job skill 710. If matched, the system will make the skills and levels matched candidates 830 ready for job preferences filtering.

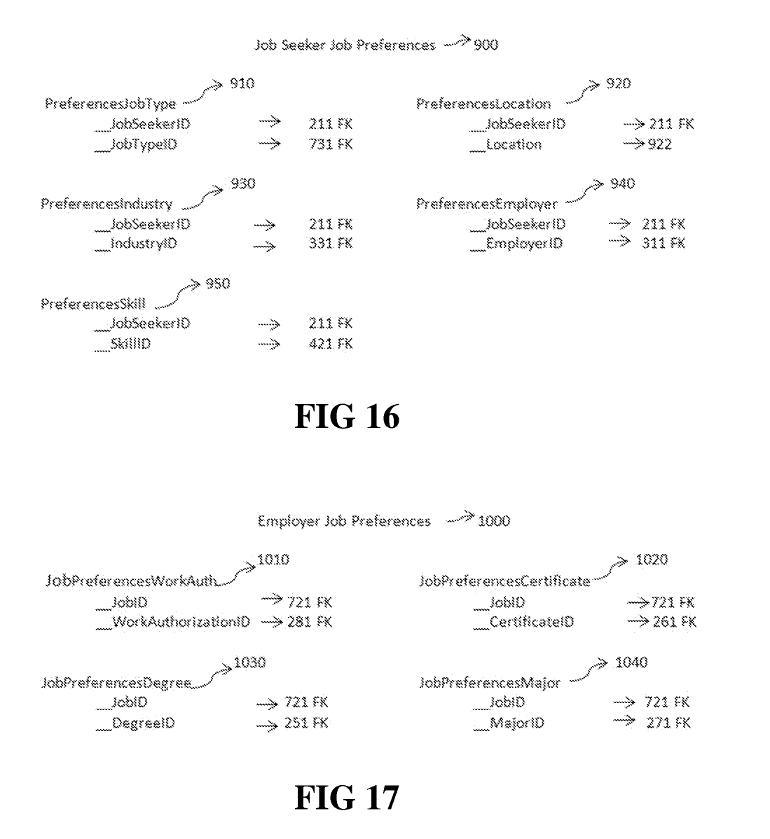

FIG. 16 shows data diagram for job seeker preferences entry 900. The job seeker 100 may want to limit the job seeker's interested jobs to preferred job types 910 such as full time job; preferred locations 920 such as in preferred cities, zip codes, within certain miles from job location; to preferred industries 930 such as Financial Service industry; to preferred employers 940; or to preferred skills 950. For a list of employers 310 in the system, the job seeker can specify which employers 940 the job seeker only be interested in. for a list of skills 420 in the system, the job seeker can specify which skills 950 the job seeker 100 only be interested in. For example, the job seeker has excellent skill A and skill B and qualified for one job looking for skill A and another job looking for skill B. In this case, the job seeker can specify that skill A is the only interested skill at skill preferences 950 to filter out the job looking for skill B

FIG. 17 shows data diagram for employer job preferences entry 1000. The employer 102 may want to limit the employer's interested job seekers for the job to have preferred work authorizations 1010, which can be entered by selecting one or more from work authorization list 280; to have preferred certificates 1020, which can be entered by selecting one or more from certificate list 260; to have preferred degrees 1030, which can be entered by selecting one or more from degree list 250; or to have preferred majors 1040, which can be entered by selecting one or more from major list 270. For example, if the employer requires the job seeker to have B.S. degree in Computer Science major with MCPD (Microsoft Certified Professional Developer) certificate, the employer can select B.S. from degree list 250 and add it to degree preferences 1030, select Computer Science from major list 270 and add it to major preferences 1040, and select MCPD certificate from certificate list 260 and add it to certificate preferences 1020.

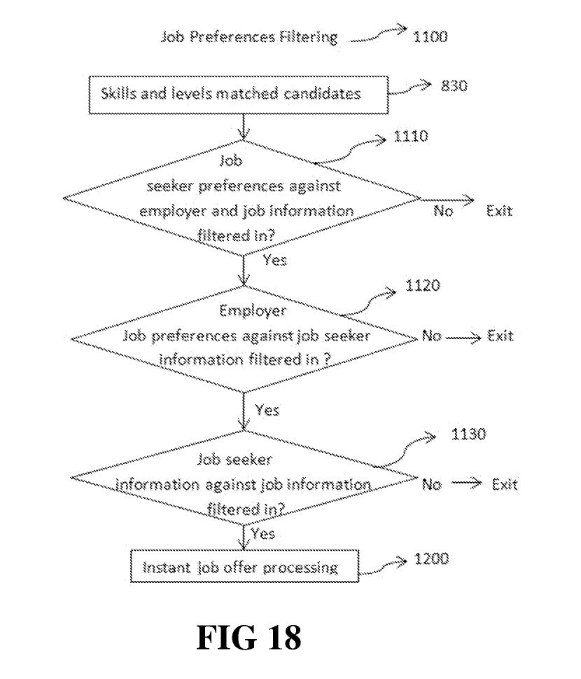

FIG. 18 shows flow diagram of job preferences filtering process 1100. For the candidates with matched skills and levels 830, the system checks job seeker job preferences 900 against employer information 300 and job information 720 for filtering. Job type filtering filters job type 731 of job seeker preferences for job type 910 against job type 731 of job information 720; Location filtering filters location 922 against location 723; Industry filtering filters industry 331 of job seeker preferences for industry 930 against industry 331 of employer industry Information 330; Employer filtering filters employer 311 of job seeker preferences for employer 940 against employer 311 of employer information 310; Skill filtering filters skill 421 of job seeker preferences for skill 950 against skill 421 of job skill information 710.

With result of filtered in for job seeker preferences filtering 1110, the system further checks employer job preferences 1000 against job seeker information 200 for filtering. Work authorization filtering filters work authorization 281 of employer job preferences for work authorization 1010 against work authorization 281 of job seeker information 210; Certificate filtering filters certificate 261 of employer job preferences for certificate 1020 against certificate 261 of job seeker certificate information 230; Degree filtering filters degree 251 of employer job preferences for degree 1030 against degree 251 of job seeker education information 220; Major filtering filters major 271 of employer job preferences for major 1040 against major 271 of job seeker education information 220.

With result of filtered in for employer job preferences filtering 1120, the system further checks job seeker information 210 against job information 720 for filtering. Salary filtering filters expected salary 214 against salary range 725; system calculates job seeker date of availability by adding days after job offer 215 to current system date, and uses the calculated job seeker availability date to filter against date range of job starting date 724. With result of filtered in for job seeker information and job information filtering 1130, the system starts processing instant job offer 1200.

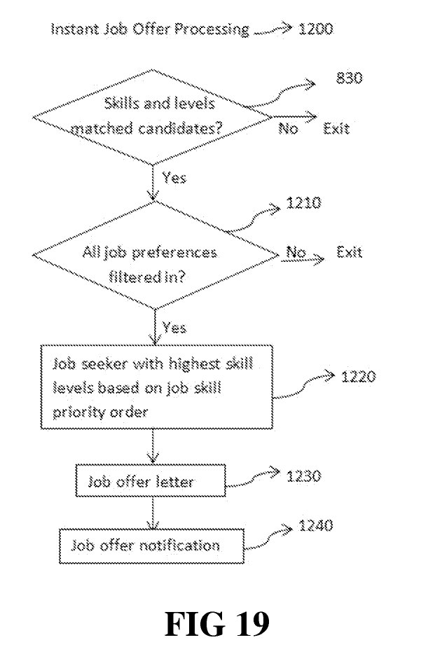

FIG. 19 shows the flow diagram of instant job offer process 1200. The system checks to see if there are skills and levels matched candidates 830. If yes, the system checks to see if there are any matched candidates having all the job preferences filtered in 1210, which includes job seeker preferences filtered in 1110, employer job preferences filtered in 1120 and job seeker information and job information filtered in 1130. If yes, the system will pick the job seeker who has highest skill levels 1220 based on job skill priority order 714. The system generates a job offer letter 1230 which includes job title 722, salary 214, job start date that is current system date plus job seeker preferred days after the offer 215, contact information of job seeker 210 and contact information of employer 310. Then the system starts job offer notification process 1230 to send job offer letter 1230 to the job seeker 100 through job seeker email address 212 and send a copy of the job offer letter 1230 to the employer 102 through employer email address 314. System then automatically closes the job 720 by setting job status 728 to Closed so that the job 720 is not available any more. System also automatically de-activates the job seeker 210 by setting job seeker status 218 to Inactive so that the job seeker 210 is not available for job skill matching any more.

The above written description is exemplary and should not be taken as limiting in any way. Various changes and modifications can be made within scope and spirit of the invention.

What is claimed is:

1. A method for evaluating a skill level of a job seeker, comprising:
building a code snippet bank;
obtaining a code snippet of the job seeker; and
determining the skill level of the job seeker based on the code snippet of the job seeker and the code snippet bank.

2. The method according to claim 1, further comprising:
obtaining information of a job provided by an employer;
determining a skill level required by the job based on the information of the job provided by the employer; and
determining whether to recommend the job seeker based on the skill level of the job seeker and the skill level required by the job provided by the employer.

3. The method according to claim 1 wherein the code snippet bank comprises predefined code snippets with different levels, and the determining a skill level of the job seeker based on the code snippet of the job seeker and the code snippet bank, comprising:
determining a grade of the code snippet of the job seeker in the code snippet bank; and
determining the skill level of the job seeker based on the grade of the code snippet of the job seeker.

4. The method according to claim 1 wherein the obtained code snippet of the job seeker comprises image information or text information.

5. The method according to claim 1 wherein the obtaining a code snippet of the job seeker comprises:
obtaining the code snippet of the job seeker through a first user input interface which is provided for the job seeker to enter the code snippet; or
obtaining the code snippet of the job seeker through a second user input interface which is provided for the job seeker to select the code snippet from a predefined code snippet bank.

6. A apparatus for evaluating a skill level of a job seeker, comprising: an input/output device, a storage device, and a processor, wherein
the input/output device and the storage device are connected to the processor through a bus;
the storage device is configured to store a code snippet bank;
the processor is configured to perform the following operations:
obtaining a code snippet of the job seeker through the input/output device; and
determining the skill level of the job seeker based on the code snippet of the job seeker and the code snippet bank.

7. The apparatus according to claim 6 wherein the processor is further configured to perform the following operations:
obtaining information of a job provided by an employer through the input/output device;
determining a skill level required by the job based on the information of the job provided by the employer; and
determining whether to recommend the job seeker based on the skill level of the job seeker and the skill level required by the job provided by the employer.

8. The apparatus according to claim 6 wherein the code snippet bank comprises predefined code snippets with different levels, and the processor is further configured to:
determining a grade of the code snippet of the job seeker in the code snippet bank; and
determining the skill level of the job seeker based on the grade of the code snippet of the job seeker.

9. The apparatus according to claim 6 wherein the obtained code snippet of the job seeker comprises image information or text information.

10. The apparatus according to claim 6 wherein the input/output device is further configured to:
provide a first user input interface for the job seeker to enter the code snippet; or
provide a second user input interface for the job seeker to select the code snippet from a predefined code snippet bank.

11. A system for evaluating a skill level of a job seeker, comprising:
Job seeker terminal, employer terminal, and server, wherein
the job seeker terminal and the employer terminal are connected to the server through a network;
the server comprising: storage device, and processor;
the storage device is connected to the processor through a bus;
the storage device is configured to store a code snippet bank;
the processor is configured to perform the following operations:
obtaining a code snippet of the job seeker through the job seeker terminal; and
determining the skill level of the job seeker based on the code snippet of the job seeker and the code snippet bank.

12. The system according to claim 11 wherein the processor is further configured to perform the following operations:
obtaining information of a job provided by an employer through the employer terminal;
determining a skill level required by the job based on the information of the job provided by the employer; and
determining whether to recommend the job seeker based on the skill level of the job seeker and the skill level required by the job provided by the employer.

13. The system according to claim 11 wherein the code snippet bank comprises predefined code snippets with different levels, and the processor is further configured to:
determining a grade of the code snippet of the job seeker in the code snippet bank; and
determining the skill level of the job seeker based on the grade of the code snippet of the job seeker.

14. The system according to claim 11 wherein the obtained code snippet of the job seeker comprises image information or text information.

15. The system according to claim 11 wherein the job seeker terminal is further configured to:
provide a first user input interface for the job seeker to enter the code snippet; or
provide a second user input interface for the job seeker to select the code snippet from a predefined code snippet bank.
